(19) United States
(12) Patent Application Publication
(10) Pub. No.: US 2018/0131540 A1
(43) Pub. Date: May 10, 2018

(54) ESTIMATING TIMING AND ANGLE INFORMATION OF WIRELESS SIGNALS

(71) Applicant: QUALCOMM Incorporated, San Diego, CA (US)

(72) Inventors: Rahul Malik, San Diego, CA (US); Bin Tian, San Diego, CA (US); Hemanth Sampath, San Diego, CA (US)

(21) Appl. No.: 15/343,852

(22) Filed: Nov. 4, 2016

(51) Int. Cl. H04L 25/02; H04L 27/26; H04B 7/04; H04L 29/06

(52) U.S. Cl. CPC H04L 25/0224; H04L 27/2628; H04W 84/12; H04L 69/22; H04B 7/04

(57) ABSTRACT

This disclosure provides systems, methods and apparatuses for estimating angular information of a received wireless signal. In some implementations, a receiving device may receive a wireless signal from a transmitting device, and estimate channel conditions, based on a number of sounding sequences, to determine a channel frequency response of the received wireless signal. The receiving device may determine a channel impulse response based an inverse discrete Fourier transfer (DFT) function or a partial inverse DFT function of the channel frequency response, and then select a portion of the channel impulse response. The receiving device may estimate an angle of arrival of the received wireless signal based on the selected portion of the channel impulse response.

### TECHNICAL FIELD

This disclosure relates generally to wireless networks, and specifically to estimating the angle of arrival or the angle of departure of signals in wireless networks.

### DESCRIPTION OF THE RELATED TECHNOLOGY

Angle of arrival (AoA) and angle of departure (AoD) information of wireless signals transmitted between devices may be estimated and thereafter used to determine the relative position and orientation between the devices. For example, signals may be received by a first device from a second device, and the first device may use AoA or AoD information of the received signals to determine a line of bearing with respect to the second device. If the location and orientation of the second device is known, then the first device may determine its position and orientation.

Because estimating AoA and AoD information is a passive positioning operation (such as the first device does not need to transmit any signals to the second device), the first device may consume less power and bandwidth compared to devices that perform active positioning operations. In addition, because positioning operations based on estimating AoA and AoD information may be performed without capturing time of arrival (TOA) or time of departure (TOD) information, the accuracy of such positioning operations is not dependent upon timing synchronization between the devices or processing delays associated with the devices.

### SUMMARY

The systems, methods and devices of this disclosure each have several innovative aspects, no single one of which is solely responsible for the desirable attributes disclosed herein.

One innovative aspect of the subject matter described in this disclosure can be implemented in a wireless network to estimate angular or timing information of wireless signals. In some aspects, a receiving device can receive a wireless signal from a plurality of transmit antennas of a transmitting device. The wireless signal can include a plurality of signal components associated with a number of different arrival paths. The receiving device can estimate channel conditions, based on a number of sounding sequences, to determine a channel frequency response of the received wireless signal. The sounding sequences can be at least one of a high efficiency long training field (HE-LTF), a very high throughput long training field (VHT-LTF), a high throughput long training field (HT-LTF), or a legacy long training field (LTF). The receiving device can determine a channel impulse response based an inverse discrete Fourier transfer (DFT) function or a partial inverse DFT function of the channel frequency response, for example, to convert a representation of the wireless signal from the frequency domain to the time domain. The receiving device can select a portion of the channel impulse response, and then estimate an angle of arrival or timing information of the received wireless signal based on the selected portion of the channel impulse response.

In some implementations, the channel impulse response can include a first channel impulse response corresponding to a first group of the signal components received from a first group of the transmit antennas, and can include a second channel impulse response corresponding to a second group of the signal components received from a second group of the transmit antennas. For such implementations, the receiving device can determine whether a first peak in the first channel impulse response corresponds to a first group of the transmit antennas or to a second group of the transmit antennas, and then detect a position of the second group of the transmit antennas based on a cyclic shift diversity (CSD) delay between the first and second groups of transmit antennas. The receiving device also can detect a second peak in the second channel impulse response, and then isolate the first channel impulse response from the second channel impulse response based, at least in part, on the detected first and second peaks.

Another innovative aspect of the subject matter described in this disclosure can be implemented as a method for estimating angular or timing information of wireless signals. The method can include receiving the wireless signal from a plurality of transmit antennas of a transmitting device, and then estimating channel conditions, based on a number of sounding sequences, to determine a channel frequency response of the received wireless signal. As mentioned above, the sounding sequences can be at least one of a HE-LTF, a VHT-LTF, a HT-LTF, or a legacy LTF. The method can include determining a channel impulse response based an inverse discrete Fourier transfer (DFT) function or a partial inverse DFT function of the channel frequency response. As mentioned above, determining a channel impulse response from the channel frequency response can convert a representation of the wireless signal from the frequency domain to the time domain. The method can include selecting a portion of the channel impulse response, and estimating an angle of arrival or timing information of the received wireless signal based on the selected portion of the channel impulse response.

Another innovative aspect of the subject matter described in this disclosure can be implemented in a non-transitory computer readable medium. The non-transitory computer-readable medium can comprise instructions that, when executed by a receiving device, cause the receiving device to perform a number of operations for estimating angular or timing information of wireless signals. The number of operations can include receiving the wireless signal from a plurality of transmit antennas of a transmitting device, and estimating channel conditions, based on a number of sounding sequences, to determine a channel frequency response of the received wireless signal. The number of operations can further include determining a channel impulse response based an inverse DFT function or a partial inverse DFT function of the channel frequency response. As mentioned above, determining a channel impulse response from the channel frequency response can convert a representation of the wireless signal from the frequency domain to the time domain. The number of operations can further include selecting a portion of the channel impulse response, and estimating an angle of arrival or timing information of the received wireless signal based on the selected portion of the channel impulse response.

Another innovative aspect of the subject matter described in this disclosure can be implemented in a receiving device. The receiving device can include means for receiving the wireless signal from a plurality of transmit antennas of a transmitting device; means for estimating channel conditions, based on a number of sounding sequences, to determine a channel frequency response of the received wireless signal; means for determining a channel impulse response based an inverse DFT function or a partial inverse DFT function of the channel frequency response; means for selecting a portion of the channel impulse response; and means for estimating an angle of arrival or timing information of the received wireless signal based on the selected portion of the channel impulse response.

Another innovative aspect of the subject matter described in this disclosure can be implemented in a transmitting device. The transmitting device can transmit a number of first sounding sequences from a first group of antennas to a receiving device, and transmit a number of second sounding sequences from a second group of antennas to the receiving device. The transmitting device can apply a cyclic shift diversity (CSD) between the first and second groups of antennas. For some implementations, the first sounding sequences can be orthogonal to each other, and the second sounding sequences can be orthogonal to each other. In some aspects, the first sounding sequences can be the same as the second sounding sequences. As mentioned above, the sounding sequences can be at least one of a HE-LTF, a VHT-LTF, a HT-LTF, or a legacy LTF.

Another innovative aspect of the subject matter described in this disclosure can be implemented as a method for performing channel estimation. The method can include transmitting a number of first sounding sequences from a first group of antennas to a receiving device, and transmitting a number of second sounding sequences from a second group of antennas to the receiving device. The method can include applying a cyclic shift diversity (CSD) between the first and second groups of antennas. For some implementations, the first sounding sequences can be orthogonal to each other, and the second sounding sequences can be orthogonal to each other.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a block diagram of a wireless system.

FIG. 2 shows a block diagram of a wireless device.

FIG. 3 shows an example table that may be used to select a number and orthogonalization of sounding sequences to be transmitted to a receiving device.

FIG. 4A shows an example transmission of a wireless signal in the presence of multipath effects.

FIG. 4B shows an example reception of multipath wireless signals at a receiving device including four antennas.

FIG. 5 shows an example channel impulse response of a wireless signal including line-of-sight (LOS) and non-LOS (NLOS) signal components.

FIG. 6 shows another example channel impulse response of a wireless signal including LOS and NLOS signal components.

FIG. 7A shows an example high efficiency (HE) packet.

FIG. 7B shows an example HE preamble packet.

FIG. 8 shows an illustrative flow chart depicting an example operation for estimating an angle of arrival (AoA) of a wireless signal.

FIG. 9A shows an illustrative flow chart depicting an example operation for selecting a portion of a channel impulse response.

FIG. 9B shows an illustrative flow chart depicting another example operation for selecting a portion of a channel impulse response.

FIG. 9C shows an illustrative flow chart depicting another example operation for selecting a portion of a channel impulse response.

FIG. 10 shows an illustrative flow chart depicting an example operation for performing a channel estimation operation.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the IEEE 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

Implementations of the subject matter described in this disclosure may be used to estimate angular and positional information of a wireless signal including a plurality of signal components associated with a number of different arrival paths. For some implementations, a receiving device may receive the wireless signal from a plurality of transmit antennas of a transmitting device. The receiving device may estimate channel conditions, based on the number of sounding sequences, to determine a channel frequency response of the received wireless signal. The receiving device may determine a channel impulse response based an inverse discrete Fourier transfer (DFT) function or a partial inverse DFT function of the channel frequency response. The receiving device may select a portion of the channel impulse response, and then estimate an angle of arrival of the received wireless signal based on the selected portion of the channel impulse response. Alternately the receiving device may compute the partial inverse DFT for the taps of the channel where the first tap/first arrival is expected to be, thus saving on computation of the inverse DFT for all channel taps.

In some implementations, the sounding sequences may be transmitted to the receiving device in one or more null data packets (NDPs), such as during channel sounding operations. In some other implementations, the sounding sequences may be contained in frames or packets transmitted to the receiving device during ranging operations. In some aspects, the sounding sequences may be contained in packet extensions of packets transmitted from the transmitting device to the receiving device. In some other aspects, the sounding sequences may be high efficiency long training fields (HE-LTFs), very high throughput long training fields (VHT-LTFs), high throughput long training fields (HT-LTFs), or legacy long training fields (LTFs).

The channel frequency response may be a frequency-domain representation of the wireless signal, and the channel impulse response may be a time-domain representation of the wireless signal. Thus, the receiving device may convert the representation of the received wireless signal from the frequency domain to the time domain by determining the channel impulse response of the wireless signal based on the channel frequency response of the wireless signal, which may improve the accuracy with which arrival of angle (AoA) information is estimated.

Particular implementations of the subject matter described in this disclosure can be implemented to realize one or more of the following potential advantages. By converting the representation of the wireless signal from the frequency domain to the time domain, the receiving device may be able to more accurately identify (and isolate) signal components associated with the direct path or line-of-sight (LOS) between the transmitting device and the receiving device, which in turn may result in more accurate AoA estimates. Additionally, the ability to convert the representation of the wireless signal from the frequency domain to the time domain may allow the receiving device to accurately distinguish between sounding sequences transmitted from a first group of antennas of the transmitting device and sounding sequences transmitted from a second group of antennas of the transmitting device.

Moreover, because the accuracy of ranging operations (such as determining a round-trip time (RTT) of signals exchanged between devices) can be related to channel estimates, the ability to obtain accurate estimates of channel conditions in the presence of multipath effects can also improve the accuracy of RTT values obtained during ranging operations. By improving the accuracy with which timing information of wireless signals may be estimated, various implementations of the subject matter described in this disclosure may further increase the accuracy of ranging operations performed between wireless devices.

As used herein, the term “HT” may refer to a high throughput frame format or protocol defined, for example, by the IEEE 802.11n standards; the term “VHT” may refer to a very high throughput frame format or protocol defined, for example, by the IEEE 802.11ac standards; the term “HE” may refer to a high efficiency frame format or protocol defined, for example, by the IEEE 802.11ax standards; and the term “non-HT” may refer to a legacy frame format or protocol defined, for example, by the IEEE 802.11a/g standards. Thus, the terms “legacy” and “non-HT” may be used interchangeably herein. In addition, the term “legacy device” as used herein may refer to a device that operates according to the IEEE 802.11a/g standards, and the term “HE device” as used herein may refer to a device that operates according to the IEEE 802.11ax or 802.11az standards. Further, as used herein, the term “timing information” may refer to one or more time values that indicate a difference in time between a time of departure (TOD) of one frame or signal from a given device and a time of arrival (TOA) of another frame or signal at the given device, and the term “angle information” may refer to information indicating a direction of one device relative to another device or to information from which the direction of one device relative to another device may be derived. In some aspects, the term “angle information” may refer to angle of arrival (AoA) information and angle of departure (AoD) information.

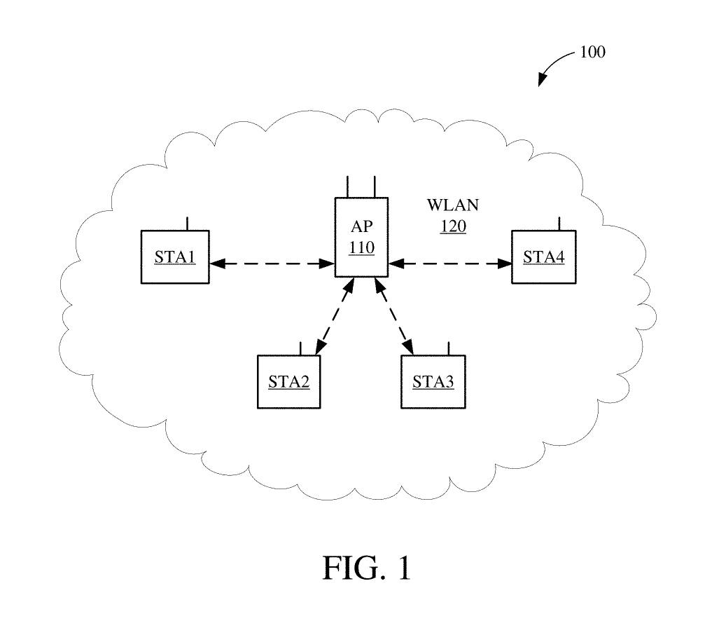

FIG. 1 shows a block diagram of an example wireless system 100 within which various aspects of the present disclosure may be implemented. The wireless system 100 is shown to include four wireless stations STA1-STA4, a wireless access point (AP) 110, and a wireless local area network (WLAN) 120. The WLAN 120 may be formed by a plurality of access points (APs) that may operate according to the IEEE 802.11 family of standards (or according to other suitable wireless protocols). Thus, although only one AP 110 is shown in FIG. 1 for simplicity, it is to be understood that WLAN 120 may be formed by any number of access points such as AP 110. The AP 110 may be assigned a unique MAC address that is programmed therein by, for example, the manufacturer of the access point. Similarly, each of stations STA1-STA4 also may be assigned a unique MAC address. Although not specifically shown in FIG. 1, for at least some implementations, the stations STA1-STA4 may exchange signals directly with each other (such as without the presence of AP 110).

For some implementations, the wireless system 100 may correspond to a multiple-input multiple-output (MIMO) wireless network, and may support single-user MIMO (SU-MIMO) and multi-user (MU-MIMO) communications. Further, although the WLAN 120 is depicted in FIG. 1 as an infrastructure Basic Service Set (BSS), for other implementations, WLAN 120 may be an Independent Basic Service Set (IBSS), an Extended Basic Service Set, an ad-hoc network, or a peer-to-peer (P2P) network (such as operating according to the Wi-Fi Direct protocols).

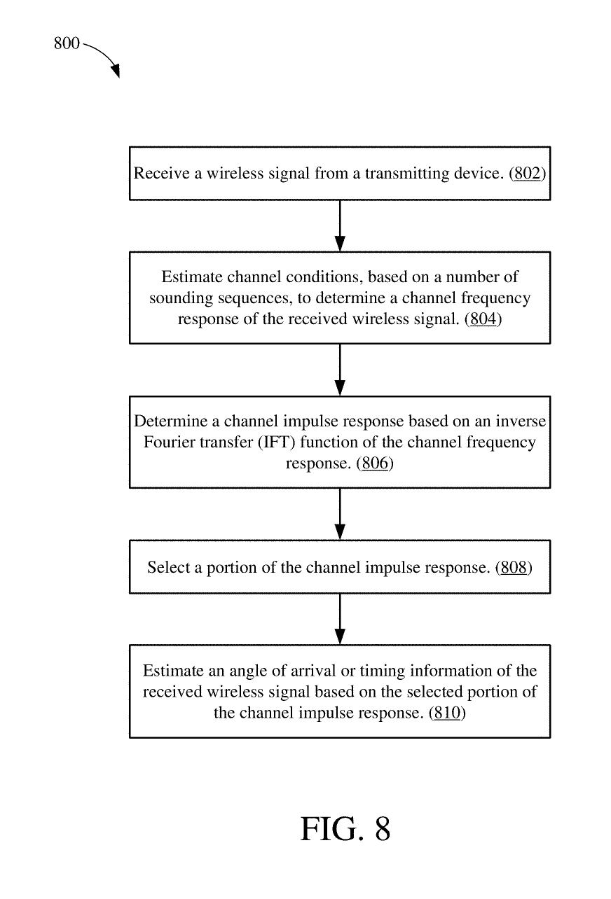

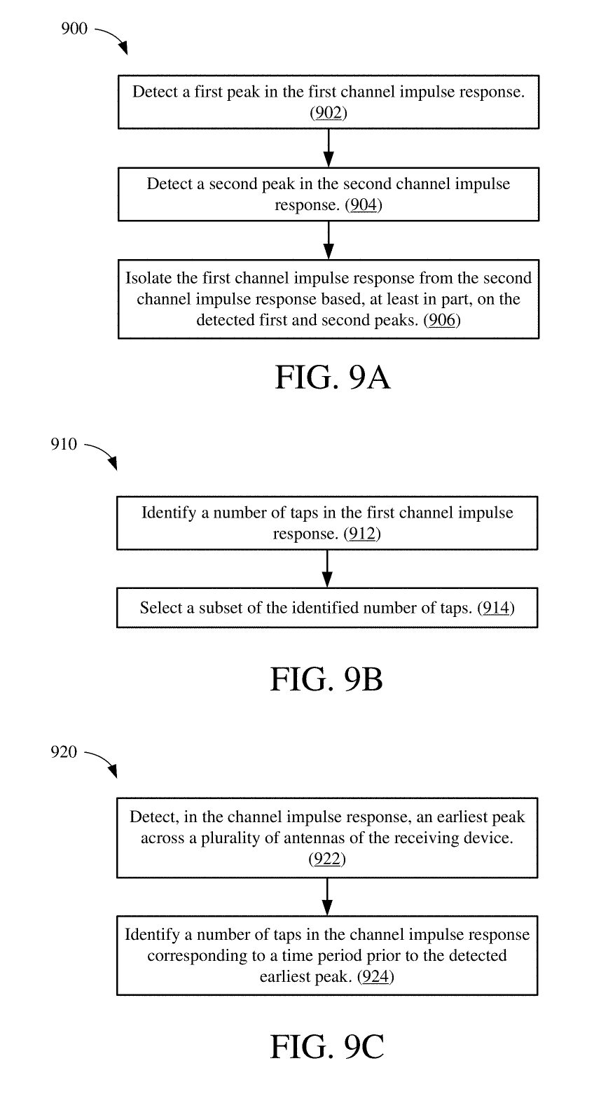

The stations STA1-STA4 may be any suitable Wi-Fi enabled wireless devices including, for example, cell phones, personal digital assistants (PDAs), tablet devices, laptop computers, or the like. The stations STA1-STA4 also may be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some implementations, each of stations STA1-STA4 may include a transceiver, one or more processing resources (such as processors or ASICs), one or more memory resources, and a power source (such as a battery). The memory resources may include a non-transitory computer-readable medium (such as one or more nonvolatile memory elements, such as EPROM, EEPROM, Flash memory, a hard drive, etc.) that stores instructions for performing operations described below with respect to FIGS. 8 and 9A-9C.

The AP 110 may be any suitable device that allows one or more wireless devices to connect to a network (such as a local area network (LAN), wide area network (WAN), metropolitan area network (MAN), or the Internet) via AP 110 using Wi-Fi, Bluetooth, cellular, or any other suitable wireless communication standards. For at least some implementations, AP 110 may include a transceiver, a network interface, one or more processing resources, and one or more memory sources. The memory resources may include a non-transitory computer-readable medium (such as one or more nonvolatile memory elements, such as EPROM, EEPROM, Flash memory, a hard drive, etc.) that stores instructions for performing operations described below with respect to FIGS. 8 and 9A-9C. For other implementations, one or more functions of AP 110 may be performed by one of stations STA1-STA4 (such as operating as a soft AP).

For the stations STA1-STA4 and AP 110, the one or more transceivers may include Wi-Fi transceivers, Bluetooth transceivers, cellular transceivers, or other suitable radio frequency (RF) transceivers (not shown for simplicity) to transmit and receive wireless communication signals. Each transceiver may communicate with other wireless devices in distinct frequency bands or using distinct communication protocols. For example, the Wi-Fi transceiver may communicate within a 2.4 GHz frequency band, within a 5 GHz frequency band, or within a 60 GHz frequency band in accordance with the IEEE 802.11 family of standards. The cellular transceiver may communicate within various RF frequency bands in accordance with the LTE protocol described by the 3rd Generation Partnership Project (3GPP) (such as between approximately 700 MHz and approximately 3.9 GHz) or in accordance with other cellular protocols (such as the GSM protocol). In some implementations, the transceivers included within the stations STA1-STA4 or the AP 110 may be any technically feasible transceiver such as a ZigBee transceiver described by a specification from the ZigBee specification, a WiGig transceiver, or a HomePlug transceiver described by a specification from the HomePlug Alliance.

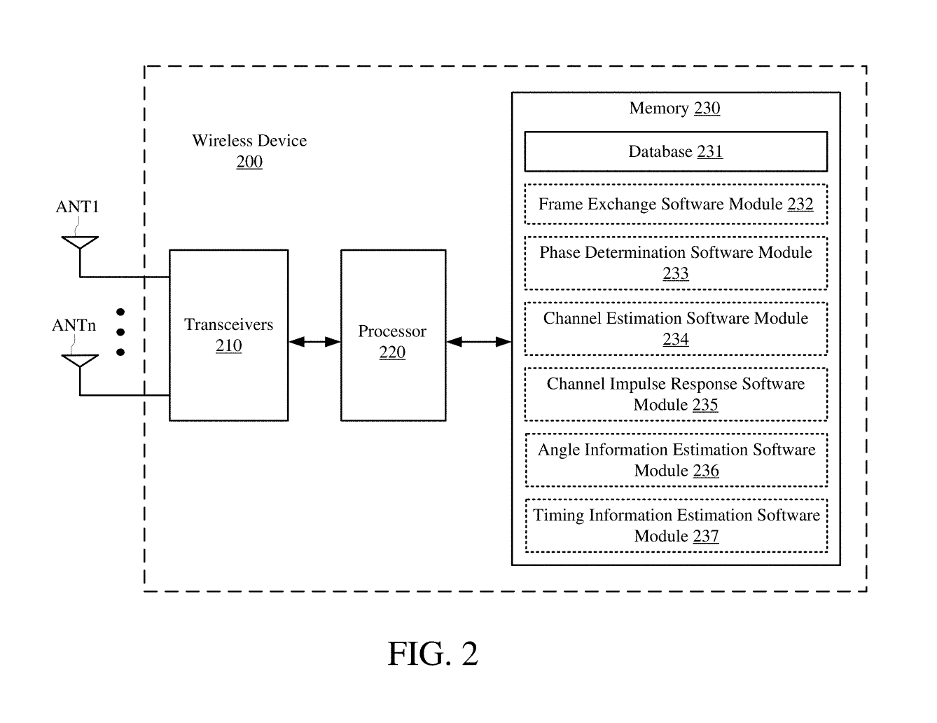

FIG. 2 shows a wireless device 200 that may be one implementation of at least one of the stations STA1-STA4 or the AP 110 of FIG. 1. The wireless device 200 may include one or more transceivers 210, a processor 220, a memory 230, and a number of antennas ANT1-ANTn. The transceivers 210 may be coupled to antennas ANT1-ANTn, either directly or through an antenna selection circuit (not shown for simplicity). The transceivers 210 may be used to transmit signals to and receive signals other wireless devices including, for example, AP 110 or one or more of stations STA1-STA4 of FIG. 1. Although not shown in FIG. 2 for simplicity, the transceivers 210 may include any number of transmit chains to process and transmit signals to other wireless devices via antennas ANT1-ANTn, and may include any number of receive chains to process signals received from antennas ANT1-ANTn. Thus, the wireless device 200 may be configured for MIMO operations. The MIMO operations may include SU-MIMO operations and MU-MIMO operations. Further, in some aspects, the wireless device 200 may use multiple antennas ANT1-ANTn to provide antenna diversity. Antenna diversity may include polarization diversity, pattern diversity, and spatial diversity.

For purposes of discussion herein, processor 220 is shown as coupled between transceivers 210 and memory 230. For actual implementations, transceivers 210, processor 220, and memory 230 may be connected together using one or more buses (not shown for simplicity).

Memory 230 may include a database 231 that may store location data, configuration information, data rates, MAC addresses, timing information, modulation and coding schemes, and other suitable information about (or pertaining to) a number of access points, stations, and other wireless devices. The database 231 also may store profile information for a number of wireless devices. The profile information for a given wireless device may include, for example, the wireless device's service set identification (SSID), channel information, received signal strength indicator (RSSI) values, goodput values, channel state information (CSI), and connection history with wireless device 200.

Memory 230 also may include a non-transitory computer-readable storage medium (such as one or more nonvolatile memory elements, such as EPROM, EEPROM, Flash memory, a hard drive, and so on) that may store the following software modules:
a frame exchange software module 232 to create and exchange frames (such as data frames, control frames, management frames, and action frames) between wireless device 200 and other wireless devices, for example, as described below with respect to FIGS. 8 and 9A-9C;
a phase determination software module 233 to determine phase information of wireless signals received from other devices, for example, as described below with respect to FIGS. 8 and 9A-9C;
a channel estimation software module 234 to estimate channel conditions and to determine a channel frequency response of wireless signals received from other devices, for example, as described below with respect to FIGS. 8 and 9A-9C;
a channel impulse response software module 235 to determine or generate a channel impulse response based, at least in part, on the estimated channel conditions or the channel frequency response provided by the channel estimation software module 234, for example, as described below with respect to FIGS. 8 and 9A-9C;
an angle information estimation software module 236 to estimate AoA and AoD information of received wireless signals based, at least in part, on phase information provided by the phase determination software module 233 and channel impulse response(s) provided by the channel impulse response software module 235, for example, as described below with respect to FIGS. 8 and 9A-9C; and
a timing information estimation software module 237 to estimate timing information (such as the TOD of transmitted signals and the TOA of received signals), for example, as described below with respect to FIGS. 8 and 9A-9C.
   Each software module includes instructions that, when executed by processor 220, may cause wireless device 200 to perform the corresponding functions. The non-transitory computer-readable medium of memory 230 thus includes instructions for performing all or a portion of the operations described below with respect to FIGS. 8 and 9A-9C.

The processor 220 may be any one or more suitable processors capable of executing scripts or instructions of one or more software programs stored in wireless device 200 (such as within memory 230). For example, the processor 220 may execute the frame exchange software module 232 to create and exchange frames (such as data frames, control frames, management frames, and action frames) between wireless device 200 and other wireless devices. The processor 220 may execute the phase determination software module 233 to determine phase information of wireless signals received from other devices. The processor 220 may execute the channel estimation software module 234 to estimate channel conditions and to determine a channel frequency response of wireless signals received from other devices. The processor 220 may execute the channel impulse response software module 235 to determine or generate a channel impulse response based, at least in part, on the estimated channel conditions or the channel frequency response provided by the channel estimation software module 234. The processor 220 may execute the angle information estimation software module 236 to estimate AoA and AoD information of received wireless signals based, at least in part, on phase information provided by the phase determination software module 233 and the channel impulse response provided by the channel impulse response software module 235. The processor 220 may execute the timing information estimation software module 237 to estimate timing information (such as the TOD of transmitted signals and the TOA of received signals).

As mentioned above, positioning operations to determine location of wireless devices are becoming increasingly important. The distance between a pair of wireless device may be determined by performing a ranging operation between the devices. A typical ranging operation is based on the propagation times of signals exchanged between the devices. For example, during a ranging operation between a first device and a second device, the first device may transmit a first signal to the second device, and the second device may respond by transmitting a second signal to the first device. The distance between the first and second devices may be derived from the round-trip time (RTT) of the first and second signals. For example, the distance (d) between the first device and the second device may be estimated as d=c*RTT/2, where c is the speed of light, and RTT is the summation of the actual signal propagation times of the first and second signals.

RTT values may be affected by processing delays associated with the first and second devices. These processing delays may vary for different devices, and are therefore typically estimated. To reduce ranging errors resulting from uncertainties in these processing delays, recent revisions to the IEEE 802.11 standards call for each ranging device to capture timestamps of incoming and outgoing signals so that the value of RTT may be determined independently of these processing delays. More specifically, the IEEE 802.11REVmc standards define ranging operations performed using Fine Timing Measurement (FTM) frames that allow each ranging device to report its timestamps (such as TOA values of received frames and TOD values of transmitted frames) to the other ranging device.

Two measurements that may be used in addition to RTT information to determine the relative positions of two wireless devices are the angle of arrival (AoA) of signals received by the devices and the angle of departure (AoD) of signals transmitted by the devices. For example, if the first device has RTT information between itself and a second device, then the first device may estimate the distance between itself and the second device. If the first device also has AoA information or AoD information for frames exchanged with the second device, then the first device may determine a direction of itself relative to the second device (such as an angle between the first device and the second device relative to a reference line or direction). The first device may then use the determined direction and the RTT information to estimate its position relative to the second device.

It is noted that because Wi-Fi ranging operations may be performed using frames transmitted as orthogonal frequency-division multiplexing (OFDM) symbols, the accuracy of RTT estimates may be proportional to the number of tones (such as the number of OFDM sub-carriers) used to transmit the ranging frames. For example, while a legacy (such as non-HT) frame may be transmitted on a 20 MHz-wide channel using 52 tones, an HT frame or VHT frame may be transmitted on a 20 MHz-wide channel using 56 tones, and an HE frame may be transmitted on a 20 MHz-wide channel using 242 tones. Thus, for a given frequency bandwidth or channel width, HT/VHT/HE frames use more tones than non-HT frames, and may therefore provide more accurate channel estimates and RTT estimates than non-HT frames. Accordingly, ranging operations performed with HE frames may be more accurate than ranging operations performed with non-HE frames.

Because the accuracy of ranging operations may be related to channel estimates, it is important for ranging devices to obtain accurate channel conditions. Sounding operations may be used to estimate the channel conditions between devices. In a typical sounding operation, a first device may transmit a null data packet (NDP) containing a number of sounding sequences that are known to a second device. The second device may use the sounding sequences to calculate a channel feedback matrix, from which channel conditions may be estimated. Many sounding operations use sounding sequences that are orthogonal to each other, for example, so that a receiving device may distinguish between sounding sequences transmitted from different antennas of the transmitting device. In some aspects, the sounding sequences contained in an NDP may include a number of high-efficiency long training fields (HE-LTFs). In other aspects, the sounding sequences may include a number of very high throughput long training fields (VHT-LTFs). In still other aspects, the sounding sequences may include a number of high throughput long training fields (HT-LTFs). In still other aspects, the sounding sequences may include a number of legacy LTFs.

The HE packets proposed by the IEEE 802.11ax specification may utilize up to four times as many symbols as VHT packets. Because the response time for processing HE packets remains the same as that defined in previous standards (such as the IEEE 802.11n and IEEE 802.11ac standards) for backwards compatibility, HE packets may include packet extensions containing dummy data (such as PHY-layer padding) to allow receiving devices more time to process the HE packets without giving up medium access.

In some implementations, the packet extensions of HE packets may contain a number of sounding sequences (such as rather than dummy data) from which channel conditions may be estimated. Thus, when HE packets are used for ranging operations, the sounding sequences contained in the HE packets may be used to estimate channel conditions, and also may be used to obtain timing information of packets or signals exchanged between wireless devices. In some aspects, angle information (such as AoA and AoD information) of HE packets exchanged between the ranging devices may be derived from channel estimates based on the sounding sequences. The HE packet extensions may contain any suitable sounding sequences from which channel estimates may be determined. For one example, the sounding sequences contained in the packet extensions may be HE-LTFs. For another example, the sounding sequences contained in the packet extensions may be VHT-LTFs. For yet another example, the sounding sequences contained in the packet extensions may be HT-LTFs. For still another example, the sounding sequences contained in the packet extensions may be legacy LTFs. In this manner, the use of sounding sequences in ranging operations may not only increase the accuracy with which the ranging devices may estimate angle information, but also may reduce (or even eliminate) the need for separate sounding operations to estimate channel conditions, and additionally may allow ranging devices to obtain multiple RTT values from each exchange of signals between the ranging devices.

The sounding sequences may be transmitted from multiple antennas of one or both ranging devices. For example, the IEEE 802.11ax specification may specify an LTF-mapping (denoted herein as a P-matrix) and a spatial-mapping (denoted herein as a Q-matrix), and may specify the sounding sequences that are to be used for different transmit antenna configurations and the duration of the packet extensions. The P-matrix also may be used to orthogonalize sounding sequences received from different antennas of the transmitting device.

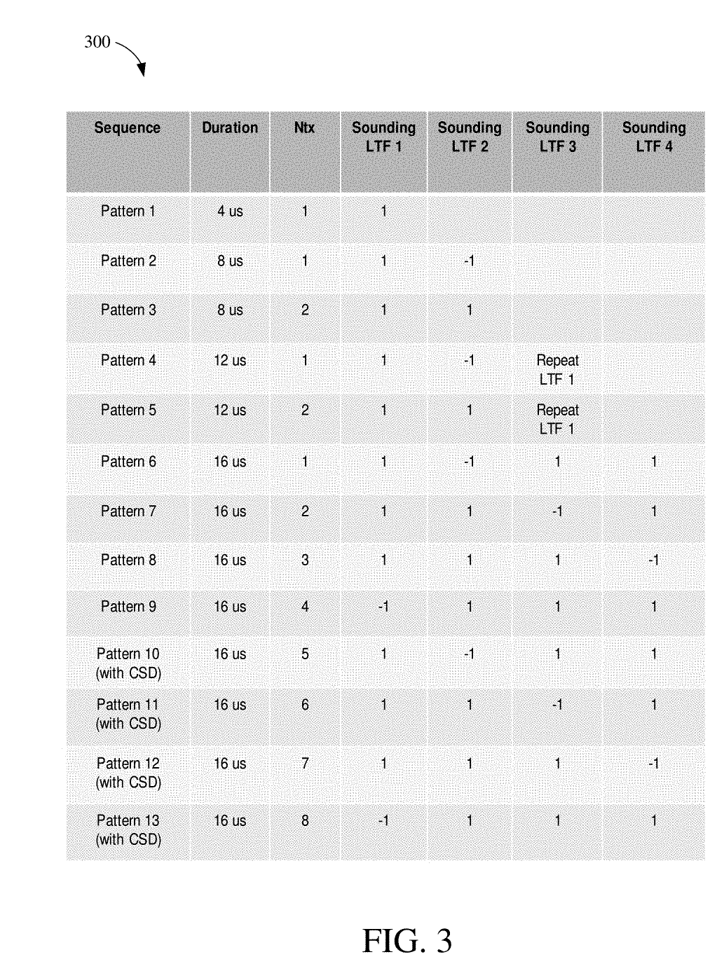

FIG. 3 shows an example table 300 indicating the number and orthogonality of sounding sequences that may be included within HE packet extensions as a function of packet extension length and the number of transmit antennas. In some aspects, the table 300 may correspond to the P-matrix specified by the IEEE 802.11ax specification. A transmitting device may use table 300 to configure the packet extensions of HE packets transmitted to a receiving device (such as during ranging operations), and the receiving device may use the table 300 to orthogonalize or decode sounding sequences contained in HE packet extensions received during ranging operations. Thus, for at least some implementations, the transmitting device and the receiving device may store the table 300 in a suitable memory (such as in memory 230 of FIG. 2). Although the sounding sequences in the example table 300 are depicted as sounding LTFs, other suitable sounding sequences may be used. In addition, for other implementations, the table 300 depicted in FIG. 3 may be used to configure the sounding sequences contained within (or otherwise associated with) NDPs used in channel sounding operations.

The example table 300 is depicted in FIG. 3 as including thirteen patterns (P1-P13) that may be used by a receiving device to estimate angle information during ranging operations. Each of the 13 patterns P1-P13 may include one or more of four sounding sequences LTF1, LTF2, LTF3, and LTF4 or rotated versions thereof. As used herein, a rotated version of a sounding LTF may be generated using sign inversion, for example, so that the original sounding LTF and the rotated sounding LTF are orthogonal to each other. For example, a rotated version of LTF1 may be denoted as −LTF1, a rotated version of LTF2 may be denoted as −LTF2, a rotated version of LTF3 may be denoted as −LTF3, and a rotated version of LTF4 may be denoted as −LTF4. In addition, each of the sounding sequences LTF1, LTF2, LTF3, and LTF4 may refer or correspond to a four (4) us slot in a HE packet extension. The use of orthogonal sounding LTFs in HE packet extensions may allow a receiving device to distinguish between sounding LTFs transmitted in different spatial streams.

The first pattern (P1) has a transmit duration of four (4) us, includes a single sounding sequence (LTF1), and may be used for HE packet extension transmissions from a single antenna. For example, if the transmitting device has a single antenna and the HE packet extension length is 4 us, then the transmitting device may transmit HE packet extensions containing the single sounding sequence LTF1 using a single antenna. Thus, if a particular HE packet extension has a transmit duration of 4 us, then the particular HE packet extension can include only one of the sounding sequences LTF1, LTF2, LTF3, and LTF4.

The second pattern (P2) has a transmit duration of eight (8) us, includes two sounding sequences (LTF1 and −LTF2), and may be used for HE packet extension transmissions from a single antenna. For example, if a transmitting device has a single antenna and the HE packet extension length is 8 us, then the transmitting device may transmit HE packet extensions containing sounding sequences LTF1 and −LTF2 using a single antenna. Thus, if a particular HE packet extension has a transmit duration of 8 us, then the particular HE packet extension can include two of the sounding sequences LTF1, LTF2, LTF3, and LTF4.

The third pattern (P3) has a transmit duration of eight (8) us, includes two sounding sequences (LTF1 and LTF2), and may be used for HE packet extension transmissions using 2 antennas. For example, if a transmitting device has 2 antennas and the HE packet extension length is 8 us, then the transmitting device may transmit the second pattern (such as containing sounding sequences LTF1 and −LTF2) as a first spatial stream via a first transmit antenna, and may transmit the third pattern (P3) (such as containing sounding sequences LTF1 and LTF2) as a second spatial stream via a second transmit antenna. In this manner, multiple antennas of the transmitting device may transmit the HE packet extension as multiple spatial streams. Further, because the sounding sequence −LTF2 transmitted via the first spatial stream is orthogonal to the sounding sequence LTF2 transmitted via the second spatial stream, a receiving device having a single antenna may distinguish between the sounding sequences transmitted from each of the transmit antennas.

The fourth pattern (P4) has a transmit duration of twelve (12) us, includes three sounding sequences (LTF1, −LTF2, and LTF1), and may be used for HE packet extension transmissions from one antenna. For example, if a transmitting device has a single antenna and the HE packet extension length is 12 us, then the transmitting device may transmit HE packet extensions containing sounding sequences LTF1, −LTF2, and LTF1 using one antenna. Thus, if a particular HE packet extension has a transmit duration of 12 us, then the particular HE packet extension can include three of the sounding sequences LTF1, LTF2, LTF3, and LTF4.

The fifth pattern (P5) has a transmit duration of twelve (12) us, includes three sounding sequences (LTF1, LTF2, and LTF1), and may be used for HE packet extension transmissions using 2 antennas. For example, if a transmitting device has 2 antennas and the HE packet extension length is 12 us, then the transmitting device may transmit the fourth pattern (P4) (such as containing sounding sequences LTF1, −LTF2, and LTF1) as a first spatial stream via a first transmit antenna, and may transmit the fifth pattern (such as containing sounding sequences LTF1, LTF2, and LTF1) as a second spatial stream via a second transmit antenna. It is noted that because the sounding sequence −LTF2 transmitted via the first spatial stream is orthogonal to the sounding sequence LTF2 transmitted via the second spatial stream, a receiving device having a single antenna may distinguish between the sounding sequences transmitted from each of the transmit antennas.

The sixth pattern (P6) has a transmit duration of sixteen (16) us, includes four sounding sequences (LTF1, −LTF2, LTF3, and LTF4), and may be used for HE packet extension transmissions from a single antenna. For example, if a transmitting device has a single antenna and the HE packet extension length is 16 us, then the transmitting device may transmit HE packet extensions containing the sounding sequences LTF1, −LTF2, LTF3, and LTF4 using one antenna. Thus, if a particular HE packet extension has a transmit duration of 16 us, the particular HE packet extension can include four of the sounding sequences LTF1, LTF2, LTF3, and LTF4.

The seventh pattern (P7) has a transmit duration of sixteen (16) us, includes four sounding sequences (LTF1, LTF2, −LTF3, and LTF4), and may be used for HE packet extension transmissions from 2 antennas. For example, if a transmitting device has 2 antennas and the HE packet extension length is 16 us, then the transmitting device may transmit the sixth pattern (P6) (such as containing the sounding sequences LTF1, −LTF2, LTF3, and LTF4) as a first spatial stream via a first transmit antenna, and may transmit the seventh pattern (P7) (such as containing sounding sequences LTF1, LTF2, −LTF3, and LTF4) as a second spatial stream via a second transmit antenna. It is noted that because the sounding sequences −LTF2 and LTF3 transmitted via the first spatial stream are orthogonal to the sounding sequences LTF2 and −LTF3 transmitted via the second spatial stream, a receiving device having a single antenna may distinguish between the sounding sequences transmitted from each of the transmit antennas.

The eighth pattern (P8) has a transmit duration of sixteen (16) us, includes four sounding sequences (LTF1, LTF2, LTF3, and −LTF4), and may be used for HE packet extension transmissions from 3 antennas. For example, if a transmitting device has 3 antennas and the HE packet extension length is 16 us, then the transmitting device may transmit the sixth pattern (P6) (such as containing sounding sequences LTF1, −LTF2, LTF3, and LTF4) as a first spatial stream via a first transmit antenna, may transmit the seventh pattern (P7) (such as containing sounding sequences LTF1, LTF2, −LTF3, and LTF4) as a second spatial stream via a second transmit antenna, and may transmit the eighth pattern (P8) (such as containing sounding sequences LTF1, LTF2, LTF3, and −LTF4) as a third spatial stream via a third transmit antenna. It is noted that the sounding LTFs transmitted via spatial streams are orthogonal to one another. In this manner, the receiving device may distinguish between the sounding sequences transmitted from each of the transmit antennas.

The ninth pattern (P9) has a transmit duration of sixteen (16) us, includes four sounding sequences (−LTF1, LTF2, LTF3, and LTF4), and may be used for HE packet extension transmissions from 4 antennas. For example, if a transmitting device has 4 antennas and the HE packet extension length is 16 us, then the transmitting device may transmit the sixth pattern (P6) (such as containing sounding sequences LTF1, −LTF2, LTF3, and LTF4) as a first spatial stream via a first transmit antenna, may transmit the seventh pattern (P7) (such as containing sounding sequences LTF1, LTF2, −LTF3, and LTF4) as a second spatial stream via a second transmit antenna, may transmit the eighth pattern (P8) (such as containing sounding sequences LTF1, LTF2, LTF3, and −LTF4) as a third spatial stream via a third transmit antenna, and may transmit the ninth pattern (P9) (such as containing sounding sequences −LTF1, LTF2, LTF3, and LTF4) as a fourth spatial stream via a fourth transmit antenna. It is noted that the sounding LTFs transmitted via spatial streams are orthogonal to one another. In this manner, the receiving device may distinguish between the sounding sequences transmitted from each of the transmit antennas.

The first nine patterns P1-P9 may be used to configure HE packet extensions when the transmitting device includes 4 or less antennas. More specifically, when the transmitting device includes 4 or less antennas, the number of spatial streams upon which the HE packet extension is transmitted may be equal to the number of antennas used to transmit the HE packet extension (such as when Ntx≤4, then Nsts=Ntx).

For at least some implementations, the HE packet extensions are to be transmitted using at most 4 spatial streams. Thus, when the transmitting device includes more than 4 antennas, the first 4 antennas may be used to transmit the HE packet extension as 4 spatial streams (such as in a manner similar to that described above with respect to the ninth pattern (P9)), and any additional antennas may be used to transmit one or more of the same 4 spatial streams with a relatively large cyclic shift diversity (CSD) value.

The tenth pattern (P10) has a transmit duration of sixteen (16) us, includes four sounding sequences (LTF1, −LTF2, LTF3, and LTF4), and may be used for HE packet extension transmissions from 5 antennas. For example, if a transmitting device has 5 antennas and the HE packet extension length is 16 us, then the transmitting device may use four antennas to transmit patterns P6-P9 (such as in the manner described above with respect to pattern P9), and may use the fifth antenna to transmit pattern P10 as another spatial stream having a relatively large CSD with respect to the first four spatial streams. In some aspects, pattern P10 may be the same as pattern P6, and thus the fifth antenna also may transmit the same pattern as the first antenna, offset in time by the CSD delay between the first and fifth transmit antennas.

The eleventh pattern (P11) has a transmit duration of sixteen (16) us, includes four sounding sequences (LTF1, LTF2, −LTF3, and LTF4), and may be used for HE packet extension transmissions from 6 antennas. For example, if a transmitting device has 6 antennas and the HE packet extension length is 16 us, then the transmitting device may use four antennas to transmit patterns P6-P9 (such as in the manner described above with respect to pattern P9), and may use the fifth and sixth antennas to transmit patterns P10 and P11 as time-offset versions of patterns P6 and P7 transmitted by the first and second antennas, respectively. In other words, the fifth and sixth antennas may transmit the same patterns as the first and second antennas, offset in time by the CSD delay.

The twelfth pattern (P12) has a transmit duration of sixteen (16) us, includes four sounding sequences (LTF1, LTF2, LTF3, and −LTF4), and may be used for HE packet extension transmissions from 7 antennas. For example, if a transmitting device has 7 antennas and the HE packet extension length is 16 us, then the transmitting device may use the first four antennas to transmit patterns P6-P9 (such as in the manner described above with respect to pattern P9), and may use the fifth, sixth, and seventh antennas to transmit patterns P10, P11, and P12 as time-offset versions of patterns P6, P7, and P8 transmitted by the first, second, and third antennas, respectively. In other words, the fifth, sixth, and seventh antennas may transmit the same patterns as the first, second, and third antennas, offset in time by the CSD delay.

The thirteenth pattern (P13) has a transmit duration of sixteen (16) us, includes four sounding sequences (−LTF1, LTF2, LTF3, and LTF4), and may be used for HE packet extension transmissions from 8 antennas. For example, if a transmitting device has 8 antennas and the HE packet extension length is 16 us, then the transmitting device may use the first four antennas to transmit patterns P6-P9 (such as in the manner described above with respect to pattern P9), and may use the second four antennas to transmit patterns P10-P13 as time-offset versions of patterns P6-P9 transmitted by the first, second, third, and fourth antennas, respectively. In other words, the first four antennas may transmit the same patterns as the second four antennas, offset in time by the CSD delay.

As described above, the sounding sequences transmitted by multiple antennas may be separated by code (such as using the P-matrix) and separated in time (such as using CSD). Additional dimensions may be incorporated into the sounding sequences by leveraging CSD for shorter PE durations. For example, an 8 us packet extension including 2 LTF symbols may be used to sound 4 antennas. The 4 antennas may be grouped into 2 antenna pairs such that each pair of antennas corresponds with a respective row of a 2-row P-matrix, and the antennas within each pair are further separated by an appropriate CSD, for example, as described above with respect to FIG. 3.

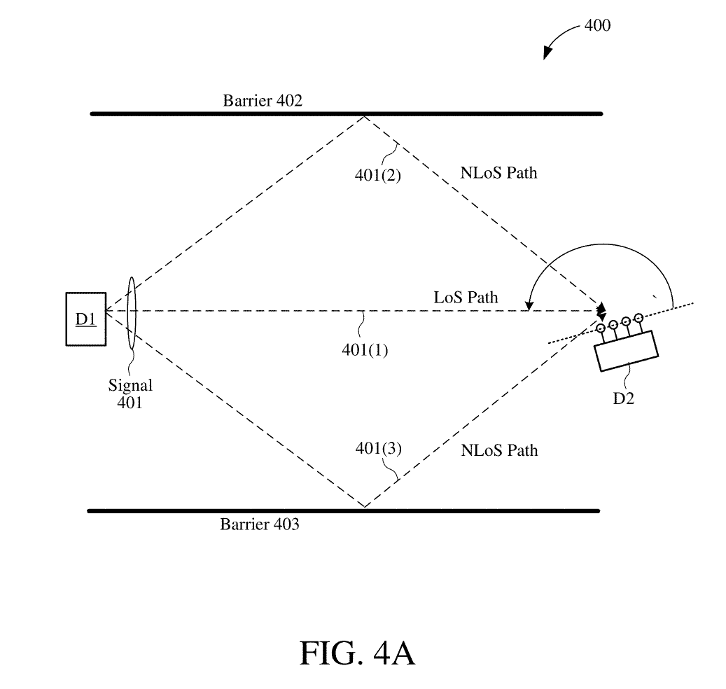

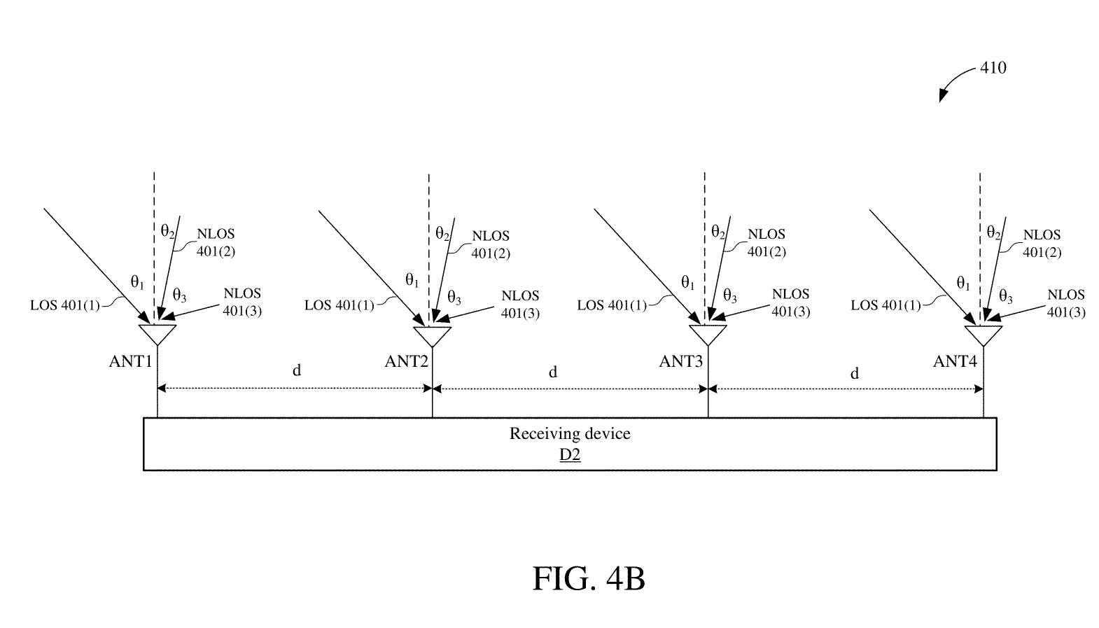

The ability of a receiving device to distinguish between sounding sequences transmitted from multiple antennas of a transmitting device may be complicated by multipath effects. For example, FIG. 4A shows an example transmission 400 of a wireless signal 401 in the presence of multipath effects. As depicted in FIG. 4A, the wireless signal 401 transmitted from a transmitting device D1 to a receiving device D2 may be influenced by multipath effects resulting, for example, from barriers 402 and 403 near devices D1 and D2. The barriers 402 and 403 may represent any physical obstruction between or near devices D1 and D2. In some aspects, the receiving device D2 may include four antennas, as depicted in FIG. 4A. In other aspects, the receiving device D2 may include more than four antennas (such as eight antennas).

More specifically, the wireless signal 401, which may include or be associated with any number of packets or frames, is shown to include a first signal component 401(1), a second signal component 401(2), and a third signal component 401(3). The first signal component 401(1) travels directly from the transmitting device D1 to the receiving device D2 along a LOS path, the second signal component 401(2) travels indirectly from the transmitting device D1 to the receiving device D2 along a NLOS path that reflects off the barrier 402, and the third signal component 401(3) travels indirectly from the transmitting device D1 to the receiving device D2 along a NLOS path that reflects off the barrier 403. As a result, the first signal component 401(1) may arrive at the receiving device D2 at different times or at different angles than the second signal component 401(2) or the third signal component 401(3).

Because the first signal component 401(1) travels along the LOS path (which is the shortest path) between devices D1 and device D2, AoA information of the first signal component 401(1) may provide a more accurate position of the receiving device D2 relative to the transmitting device D1 than AoA information of the second signal component 401(2) or the third signal component 401(3). Thus, when determining the position of the receiving device D2 relative to the transmitting device D1, it may be desirable to use AoA information of the first signal component 401(1) while ignoring (or at least placing lesser emphasis on) the second signal component 401(2) and the third signal component 401(3).

It is noted that although only two NLOS signal paths are depicted in FIG. 4A, the wireless signal 401 may have any number of signal components that travel along any number of NLOS paths between the transmitting device D1 and the receiving device D2. Further, although the first signal component 401(1) is depicted in the example of FIG. 4A as being received by the receiving device D2 without intervening reflections (such as such that the AoA of the first signal component 401(1) is substantially the same as the relative positional angle between the transmitting device D1 and the receiving device D2), for other examples, the first signal component 401(1) may be reflected one or more times before received by the receiving device D2.

If the signal 401 contains one or more patterns (such as sounding sequences) known to the receiving device D2, then the receiving device D2 may estimate channel conditions and determine the channel frequency response of the wireless signal 401. The receiving device D2 may determine a channel impulse response by taking an inverse discrete Fourier transfer (DFT) function or a partial inverse DFT function of the channel frequency response. The channel impulse response may allow the receiving device D2 to distinguish between multipath signal components.

More specifically, by converting a representation of the wireless signal 401 from the frequency domain (as indicated by the channel frequency response) to the time domain (as indicated by the channel impulse response), the receiving device D2 may be able to more accurately identify signal components associated with the LOS between the transmitting device D1 and the receiving device D2. This may allow the receiving device D2 to determine phase information of only the identified signal components, from which more accurate angle information may be estimated (such as compared to angle information estimates based on phase information determined for all received signal components). Additionally, the receiving device D2 may derive timing information from the identified signal components to obtain more accurate RTT values indicative of the distance between the transmitting device D1 and the receiving device D2 (such as compared to ranging operations from which timing information is derived from all signal components), which in turn may further increase ranging accuracy.

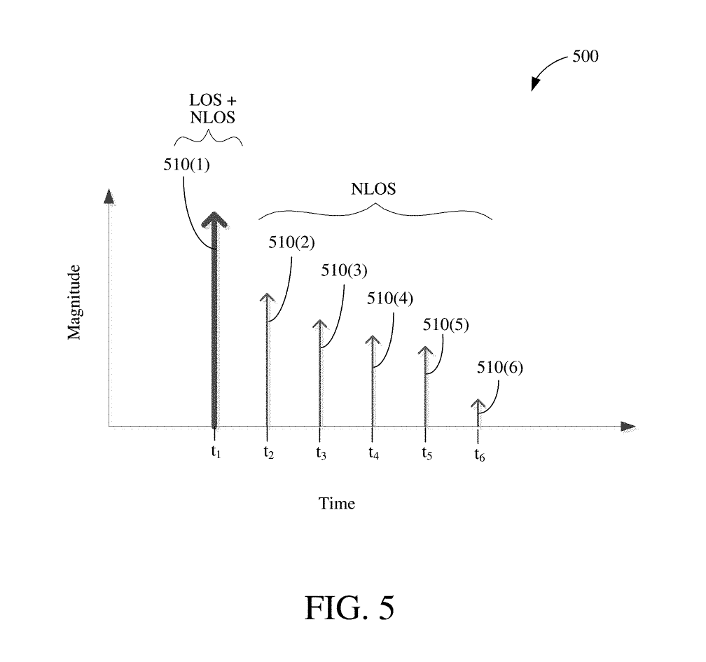

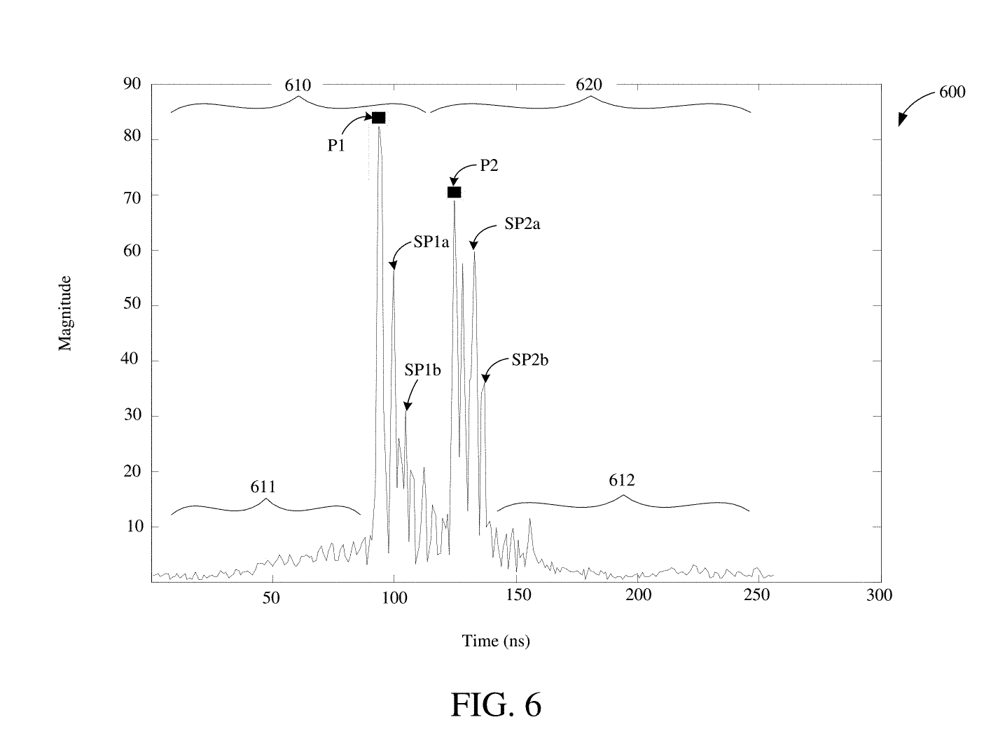

In some aspects, the receiving device may select a portion (such as a subset of taps) of the channel impulse response, and then determine a covariance matrix based on the selected portion of the channel impulse response. In this manner, the receiving device may effectively reduce the number of multipath or NLOS signal components (relative to the direct path or LOS signal component(s)) from which the covariance matrix is determined, thereby increasing the accuracy of estimated phase information (such as compare to conventional techniques that base the covariance matrix on all samples of the received signal). The determination and analysis of channel impulse responses are described in more detail with respect to FIGS. 5 and 6.

FIG. 4B is a multipath illustration 410 depicting reception of the wireless signal 401 at four antennas ANT1-ANT4 of the receiving device D2. For the example of FIG. 4B, the wireless signal 401 is depicted as including three signal components 401(1)-401(3): the first signal component 401(1) travels along a LOS path to the receiving device D2, and arrives at each of the antennas ANT1-ANT4 at a first angle θ₁; the second signal component 401(2) travels along one NLOS path to the receiving device D2, and arrives at each of the antennas ANT1-ANT4 at a second angle θ₂; the third signal component 401(3) travels along another NLOS path to the receiving device D2, and arrives at each of the antennas ANT1-ANT4 at a third angle θ₃.

It is noted that although only two NLOS signal paths associated with arrival angles θ₂ and θ₃, are depicted in the example of FIG. 4B, the wireless signal 401 may include any number of signal components that may travel along any number of NLOS paths or may arrive at any number of corresponding angles. In addition, although the receiving device D2 is depicted as including four antennas ANT1-ANT4 in the example FIG. 4B, the receiving device D2 may include any number of antennas. Similarly, although not shown in FIG. 4B, the transmitting device may include any number of antennas. For implementations in which the transmitting device includes 8 antennas, the transmitting device may transmit a number sounding sequences from a first group of four antennas and also transmit the number of sounding sequences from a second group of four antennas, where transmission of the sounding sequences from the second group of four antennas is offset in time from transmission of the sounding sequences from the first group of four antennas by a CSD delay provided between the first and second groups of four antennas, for example, as described with respect to FIG. 3.

In general, assuming a half-wavelength distance d between antennas, the signal yk(t) received by a device including a number “k” of antennas may be expressed as:

$${y}_{k} ( t ) = {\sum }_{i}^{ } {h}_{i} x ( t - {τ}_{i} - \frac{kd}{c} sin {θ}_{i} ) \approx {\sum }_{i}^{ } {h}_{i} {e}^{- j π ksin {θ}_{i}} x ( t - {τ}_{i} ) .$$

The receiving device D2 may estimate AoA information for all signal components (such as arriving along various signal paths) using well-known AoA estimation techniques including, for example, ESPRIT (Estimation of Signal Parameters via Rotational Invariance Techniques) and MUSIC (MUltiple SIgnal Classification). These well-known AoA estimation techniques are based on the covariance matrix of the received signal, which as described above typically contains both the LOS signal component and all NLOS signal components.

The accuracy of estimated AoA and range information may be improved by removing a number of NLOS signal components from a representation of the wireless signal prior to estimating AoA information. The ability to convert a representation of a wireless signal from the frequency domain to the time domain may allow a receiving device to more accurately identify (and isolate) signal components associated with the direct path or LOS between the transmitting device and the receiving device.

More specifically, the receiving device may estimate channel conditions based on the reception of a number of sounding sequences that are known to the receiving device. In some implementations, the sounding sequences may be transmitted to the receiving device in one or more NDPs (such as during channel sounding operations). In some other implementations, the sounding sequences may be contained in frames or packets transmitted to the receiving device during ranging operations. In some aspects, the sounding sequences may be contained in packet extensions of HE packets transmitted from the transmitting device to the receiving device, for example, as described with respect to FIG. 3. In some other aspects, the sounding sequences may be contained in the preambles of packets transmitted from the transmitting device to the receiving device. As described above, the sounding sequences may be HE-LTFs, VHT-LTFs, HT-LTFs, legacy LTFs, or any other suitable sequences or patterns from which channel information may be estimated.

The receiving device may use the estimated channel conditions to determine a channel frequency response of the wireless signal, and may then determine a channel impulse response based on the channel frequency response. When the wireless signal is transmitted from a plurality of antennas of the transmitting device, the receiving device may use the estimated channel conditions to determine a channel frequency response of the wireless signal from the plurality of transmit antennas. The ability to convert the representation of the wireless signal from the frequency domain to the time domain may allow the receiving device to accurately distinguish between sounding sequences transmitted from a first group of antennas of the transmitting device and sounding sequences transmitted from a second group of antennas of the transmitting device.

In some implementations, the receiving device may determine the channel impulse response by taking an inverse discrete Fourier transform (DFT) function or a partial inverse DFT function of the channel frequency response. As mentioned above, the receiving device may then select a portion of the channel impulse response from which phase and angle information is derived, thereby removing undesirable NLOS signal components from the determination of angle information. In this manner, the receiving device may obtain more accurate estimates of angle information (such as compared with conventional techniques), as described in more detail with respect to FIGS. 5-6.

FIG. 5 shows an example channel impulse response 500 of a received signal in the presence of multipath effects. For purposes of discussion herein, the receiving device may determine the channel impulse response 500 by taking the inverse DFT function of the channel frequency response of the wireless signal 401 described above with respect to FIGS. 4A-4B. Thus, in some aspects, the channel impulse response 500 may be a time-domain representation of the wireless signal 401 of FIGS. 4A-4B. For example, because the wireless signal 401 of FIGS. 4A-4B includes an LOS signal component 401(1) and a number of NLOS signal components 401(2)-401(3), the channel impulse response 500 of FIG. 5 may be a superposition of multiple sinc pulses, each associated with a corresponding peak or “tap” at a corresponding time value.

More specifically, the channel impulse response 500 is shown to include a main peak or tap 510(1) occurring at approximately time t₁ and a number of secondary peaks or taps 510(2)-510(6) occurring at approximately times t₂, t₃, t₄, t₅, and t₆, respectively. The main peak 510(1), which has a greater magnitude than any of the secondary taps 510(2)-510(6), may represent signal components traveling along the first arrival path (FAP) between the transmitting device D1 and the receiving device D2. For some implementations, the main peak 510(1) can be the first arrival in the channel impulse response 500, and can represent the LOS signal components as well as one or more NLOS signal components that may arrive at the receiving device D2 at the same time (or nearly the same time) as the LOS signal components. The secondary taps 510(2)-510(6) can be later arrivals in the channel impulse response 500, and can represent the NLOS signal components arriving at the receiving device D2.

Because NLOS signal components typically arrive at the receiving device later than the FAP signal components, the main peak 510(1) of the channel impulse response 500 may provide more accurate phase information than the secondary taps 510(2)-510(6) of the channel impulse response 500. Thus, for some implementations, the main peak 510(1) may be used to derive AoA information of the received wireless signal 401.

For some implementations, the channel impulse response 500 may be a time-domain representation of a wireless signal transmitted from a plurality of transmit antennas. For example, if the transmitting device includes four antennas, each of the four transmit antennas may transmit a corresponding one of four sounding sequences to the receiving device. In some aspects, the four sounding sequences may be orthogonal to each other, for example, by using the P-matrix encoding described above with respect to FIG. 3.

FIG. 6 shows another example channel impulse response 600 of a received signal in the presence of multipath effects. For purposes of discussion herein, the receiving device may determine the channel impulse response 600 by taking the inverse DFT function of the channel frequency response of the wireless signal 401 described above with respect to FIGS. 4A-4B. Thus, in some aspects, the channel impulse response 600 may be a time-domain representation of the wireless signal 401 of FIGS. 4A-4B. It is noted that because the wireless signal 401 of FIGS. 4A-4B includes an LOS signal component 401(1) and a number of NLOS signal components 401(2)-401(3), the channel impulse response 600 may be a superposition of multiple sync pulses, each associated with a corresponding peak or “tap” at a corresponding time value.

In contrast to the channel impulse response 500 depicted in FIG. 5, the channel impulse response 600 of FIG. 6 may be composed of a first channel impulse response 610 and a second channel impulse response 620. The first channel impulse response 610 may correspond to a first group of signal components received from a first set of antennas of the transmitting device, and the second channel impulse response 620 may correspond to a second group of signal components received from a second set of antennas of the transmitting device. The first channel impulse response 610 is shown to include a dominant tap or first peak P1, and the second channel impulse response 620 is shown to include a dominant tap or second peak P2. The first peak P1 and the second peak P2 may be separated or offset in time by a duration associated with a CSD delay applied between the first and second groups of antennas of the transmitting device, for example, as described above with respect to FIG. 3.

In some implementations, the channel impulse response 600 may be a time-domain representation of a transmission of patterns P6-P9 of FIG. 3 from the first four antennas of the transmitting device and a transmission of patterns P10-P13 of FIG. 3 from the second four antennas of the transmitting device. As described above with respect to FIG. 3, patterns P6 and P10 are the same as each other, patterns P7 and P11 are the same as each other, patterns P8 and P12 are the same as each other, and patterns P9 and P13 are the same as each other. Thus, the first and fifth antennas of the transmitting device may transmit the same sounding sequence (such as LFT1) separated in time by a CSD delay, the second and sixth antennas of the transmitting device may transmit the same sounding sequence (such as −LFT2) separated in time by the CSD delay, the third and seventh antennas of the transmitting device may transmit the same sounding sequence (such as LFT3) separated in time by the CSD delay, and the fourth and eighth antennas of the transmitting device may transmit the same sounding sequence (such as LFT4) separated in time by the CSD delay.

Because each of patterns P6-P9 (and thus each of patterns P10-P13) are orthogonal to one another (such as according to an encoding associated with the P-matrix of FIG. 3), the channel impulse response 600 depicted in FIG. 6 may be the inverse DFT function of the channel frequency response of wireless signals received from the first and second groups of antennas of the transmitting device. Thus, in some aspects, the first channel impulse response 610 may represent the signal transmission of a sounding sequence from one group of four transmit antennas, and the second channel impulse response 620 may represent the signal transmission of the sounding sequence from the other group of four transmit antennas. The time offset between the first peak P1 and the second peak P2 may correspond to the CSD delay applied between the first four antennas and the second four antennas of the transmitting device.

Referring again to FIG. 6, the first peak P1 may correspond to the FAP of the wireless signal 401 at the receiving device D2, which in turn may imply that the most accurate AoA information may be derived from the LOS signal component 401(1) of the received wireless signal 401, for example, rather than from other signal components (such as the NLOS signal components 401(2)-401(3)) of the received wireless signal 401. Thus, for some implementations, the receiving device D2 may isolate the first channel impulse response 610 from the second channel impulse response 620 based, at least in part, on detection of the first and peaks P1 and P2. More specifically, the first channel impulse response 610 may represent signals containing that are first to arrive at the receiving device, and the second channel impulse response 620 may represent signals containing the sounding sequence that are later to arrive at the receiving device. Thus, the second channel impulse response 620 may not correspond to the FAP and may therefore be removed from an estimation of AoA information of the received wireless signal 401.

The receiving device may determine whether the first peak P1 corresponds to the first group of transmit antennas or to the second group of transmit antennas, for example, to determine whether the first channel impulse response 610 represents signal components transmitted from the first group of transmit antennas or represents signal components transmitted from the second group of transmit antennas. If the first channel impulse response 610 represents signal components transmitted from the first group of transmit antennas, then the receiving device may determine a position of the second group of transmit antennas based on the CSD delay between the first and second groups of transmit antennas. Similarly, if the first channel impulse response 610 represents signal components transmitted from the second group of transmit antennas, then the receiving device may determine a position of the first group of transmit antennas based on the CSD delay between the first and second groups of transmit antennas.

After isolating the first channel impulse response 610, the receiving device D2 may select a portion of the first channel impulse response 610 to be used in estimating the AoA information of the received wireless signal 401. For some implementations, the receiving device D2 may select the first peak P1 and a number of taps within an earliest arrival portion 611 of the first channel impulse response 610 as a selected subset of taps of the channel impulse response, and then determine channel information of the received signal based on the selected subset of taps. Thereafter, the receiving device D2 may estimate AoA information based on the determined channel information. In some aspects, determination of the channel information may be based on a covariance matrix of the selected subset of taps. In this manner, the receiving device D2 may select the most relevant taps of the channel impulse response 600 for the covariance matrix determination, which in turn may increase the accuracy of the estimated AoA information (such as compared to conventional AoA estimation techniques for which the covariance matrix is determined for all taps of the channel impulse response 600). In other words, by selecting the subset of taps in the first channel impulse response 610 corresponding to the earliest arriving signal components of the wireless device 401, the resultant covariance matrix may be less affected by later arriving NLOS signal components of the wireless signal 401, which in turn may result in more accurate estimates of AoA information.

In some other implementations, rather than taking the inverse DFT function of the entire channel frequency response, the receiving device D2 may take a partial inverse DFT function of the channel frequency response, for example, so that the resultant channel impulse response does not include the second channel impulse response 620 representing the reception of signals transmitted by the second four antennas of the transmitting device.

In some environments, signal components corresponding to the FAP of the received wireless signal 401 may be attenuated, which in turn may result in one of the NLOS signal components having a reception strength greater than the FAP signal components. It is noted that a trough in the channel impulse response may result either from an absence of signal components at a corresponding time or from destructive interference between two or more signal components arriving at the corresponding time. The receiving device D2 may leverage timing synchronization between its receive chains or between its antennas to determine whether the trough in the channel impulse response results from an absence of signal components or from destructive interference.

More specifically, because differences in arrival times of various signal components of a received signal are typically less than the timing offset between taps in the channel impulse response, destructive interference on multiple antennas of the receiving device D2 is unlikely, for example, because the antennas are separated from one another in space (such as by the distance “d” discussed above with respect to FIGS. 4A-4B). The distance between the antennas of the receiving device D2 may imply that a given signal component may arrive at the antennas at different times. Accordingly, for some implementations, the receiving device D2 may determine the earliest peak in the channel impulse response across all of its antennas. In other words, because the antennas are time synchronized with each other but offset in space, it is unlikely that destructive interference would happen at all the antennas of the receiving device D2 at the same time.

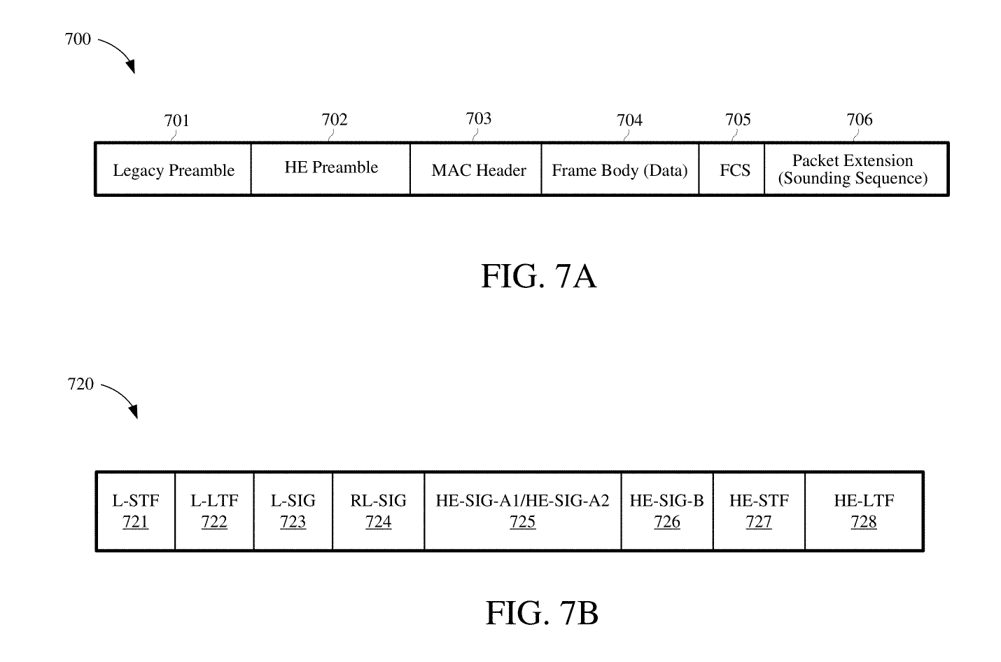

FIG. 7A shows an example high efficiency (HE) packet 700. In some aspects, the HE packet 700 may be used to transmit wireless signals from a transmitting device to a receiving device in the example described above. The HE packet 700 is shown to include a legacy preamble 701, a HE preamble 702, a MAC header 703, a frame body 704, a frame check sequence (FCS) field 705, and a packet extension 706.

The legacy preamble 701 may include synchronization information, timing information, frequency offset correction information, and signaling information. The HE preamble 702 also may include synchronization information, timing information, frequency offset correction information, and signaling information.

The MAC header 703 may contain information describing characteristics or attributes of data encapsulated within the frame body 704, may include a number of fields indicating source and destination addresses of the data encapsulated within the frame body 704, and may include a number of fields containing control information. More specifically, although not shown for simplicity, the MAC header 703 may include, for example, a frame control field, a duration field, a destination address field, a source address field, a BSSID field, and a sequence control field.

The frame body 704 may store data including, for example, one or more information elements (IEs) that may be specific to the frame type indicated in the MAC header 703. The FCS field 705 may include information used for error detection and data recovery.

The packet extension 706 does not typically store any data, but rather stores “dummy” data or padding, for example, to allow a receiving device more time to decode HE packet 700 without giving up medium access. In some aspects, the packet extension 706 may contain a number of sounding sequences from which channel estimates, AoA information, AoD information, or RTT values may be derived.

FIG. 7B shows an example preamble 720 of an HE packet. The preamble 720 may be one implementation of the preamble 701 of packet 700 of FIG. 7A. The preamble 720, which may be compliant with the IEEE 802.11ax standards, is shown to include a Legacy Short Training Field (L-STF) 721, a Legacy Long Training Field (L-LTF) 722, a Legacy Signal (L-SIG) field 723, a Repeated Legacy Signal (RL-SIG) field 724, a set of HE Signal-A (HE-SIG-A1/HE-SIG-A2) fields 725, a HE Signal B (HE-SIG-B) field 726, a HE Short Training Field (HE-STF) 727, and an HE Long Training Field (HE-LTF) 728.

The L-STF 721 may include information for coarse frequency estimation, automatic gain control, and timing recovery. The L-LTF 722 may include information for fine frequency estimation, channel estimation, and fine timing recovery. In some aspects, the L-LTF 722 may include information from angle information or RTT measurements may be determined.

The L-SIG field 723 may include modulation and coding information. The RL-SIG field 724, which may be used to identify packet 800 as an HE packet, may include a time-domain waveform generated by repeating the time-domain waveform of the L-SIG field 723. The HE-SIG-A1 and HE-SIG-A2 fields 725 may include parameters such as an indicated bandwidth, a payload guard interval (GI), a coding type, a number of spatial streams (Nsts), a space-time block coding (STBC), beamforming information, and so on.

More specifically, the HE-SIG-A1 and HE-SIG-A2 fields 725 may include a set of fields to store parameters describing the type of information stored in the HE-LTF 728 (such as whether the HE-LTF 728 is configured with information from which a receiving device may obtain an RTT measurement or angle information). For example, the set of fields includes (1) a CP+LTF Size field that stores a cyclic prefix (CP) value and a length of the HE-LTF 728; (2) an Nsts field to store information indicating the number spatial streams, (3) a STBC field store a value for space-time block coding, and (4) a transmit beamforming (TxBF) field to store information pertaining to beamforming.

The HE-SIG-B field 726 may include resource unit (RU) allocation information associated with orthogonal frequency division multiple access (OFDMA) transmissions.

Information contained in the HE-STF 727 may be used to improve automatic gain control estimates for SU-MIMO and MU-MIMO communications, and information contained in the HE-LTF 728 may be used to estimate various MIMO channel conditions. In some aspects, the HE-LTF 728 may include information from which channel estimates or angle information may be determined.

FIG. 8 shows an illustrative flow chart depicting an example operation 800 for estimating an angle of arrival (AoA) or timing information of a wireless signal. For purposes of discussion herein, a transmitting device may transmit a wireless device to a receiving device, and the receiving device may estimate the AoA of the wireless signal. The transmitting device may be any suitable wireless device including, for example, one of the stations STA1-STA4 of FIG. 1, the AP 110 of FIG. 1, or the wireless device 200 of FIG. 2. Similarly, the receiving device may be any suitable wireless device including, for example, one of the stations STA1-STA4 of FIG. 1, the AP 110 of FIG. 1, or the wireless device 200 of FIG. 2.

First, the receiving device may receive a wireless signal including a plurality of signal components associated with a number of different arrival paths (802). For example, as described above with respect to FIG. 3A, the wireless signal may include a first signal component that travels along a line-of-sight (LOS) path between the devices, and may include a number of second signal components that travel along one or more non-LOS (NLOS) paths between the devices. Thus, in some aspects, the plurality of signal components may arrive at the receiving device at different times or at different angles.

The receiving device may estimate channel conditions, based on a number of sounding sequences, to determine a channel frequency response of the received wireless signal (804). The channel frequency response, which may be indicative of MIMO channel conditions, provides a representation of the wireless signal in the frequency domain. In some aspects, the channel frequency response may be of a wireless signal transmitted from a plurality of antennas of the transmitting device.

As described above, to accurately estimate channel conditions, the receiving device need to know (in advance) what data is being transmitted on the channel. Thus, use of sounding sequences may allow for an accurate estimation of MIMO channels, which in turn may increase the accuracy with which AoA is estimated by the receiving device. The sounding sequences may be orthogonal to each other, for example, as described above with respect to FIG. 3. Thus, in some aspects, the sounding sequences may be HE-LTFs, VHT-LTFs, HT-LTFs, or legacy LTFs. In addition, for implementations in which the sounding sequences are transmitted from first and second groups of transmit antennas, the sounding sequences transmitted by the first group of antennas may be offset from the sounding sequences transmitted by the second group of antennas by a CSD delay, for example, as described above with respect to FIG. 3. For some implementations, the sounding sequences may be transmitted with the wireless signal, for example, by embedding the sounding sequences within the packet extensions of packets corresponding to the wireless signal. For other implementations, the sounding sequences may be contained within a NDP used in MIMO channel sounding operations.

The receiving device may determine a channel impulse response based an inverse discrete Fourier transfer (DFT) function of the channel frequency response (806). As described above, the inverse DFT function may be used to convert the representation of the received wireless signal from the frequency domain (such as the channel frequency response) to the time domain (such as the channel impulse response). The channel impulse response may be used to determine which signal components of the wireless signal correspond to the first arrival path (such as which signal components arrive at the receiving device first). In other aspects, the receiving device may use a partial inverse DFT function to generate the channel impulse response. In other aspects, the receiving device may use an inverse fast Fourier transfer (IFFT) function to generate the channel impulse response.

The receiving device may select a portion of the channel impulse response (808). For one example, referring also to FIG. 5, the receiving device may select the first peak T0 and a number of taps within an earliest arrival portion 520 of the channel impulse response 500 as a subset of taps from which channel information may be determined. In some aspects, the channel information may be based on a covariance matrix of the subset of taps of the channel impulse response. For another example, referring also to FIG. 6, the receiving device may select the first peak P1 and a number of taps within an earliest arrival portion 611 of the first channel impulse response 610 as a subset of taps from which channel information may be determined. In some aspects, the channel information may be based on a covariance matrix of the subset of taps of the first channel impulse response 610.

The receiving device may estimate an angle of arrival or timing information of the received wireless signal based on the selected portion of the channel impulse response (810). For some implementations, the receiving device may determine channel information of the wireless signal based on the selected subset of the identified number of taps, and then derive the angle of arrival based, at least in part, on the determined channel information. In some aspects, the receiving device may determine a covariance matrix of the selected subset of the identified number of taps to determine the channel information, and may thereafter estimate AoA information from the determined phase information.

Additionally, the receiving device may derive timing information from the selected portion of the channel impulse response. The derived timing information, which can include time of arrival (TOA) and time of departure (TOD) information, may be used to obtain a number of RTT values between the transmitting device and the receiving device, and the number of RTT values may be used to determine a distance between the transmitting device and the receiving device. Because timing information derived from the selected portion of the channel impulse response may correspond to the signal components that are first to arrive at the receiving device, the resulting RTT values may be more accurate (such as compared to ranging operations from which timing information is derived from all signal components received at the receiving device).

FIG. 9A shows an illustrative flow chart depicting an example operation 900 for selecting a portion of a channel impulse response. The receiving device may detect a first peak in the first channel impulse response (902), and may detect a second peak in the second channel impulse response (904). For example, referring to FIG. 6, the receiving device may detect the first peak P1 in the first channel impulse response 610 and may detect the second peak P2 in the second channel impulse response 620.

The receiving device may isolate the first channel impulse response from the second channel impulse response based, at least in part, on the detected first and second peaks (906). For example, referring to FIG. 6, the receiving device may use the time offset between the first and second peaks P1 and P2 to remove the second channel impulse response 620 from determination of a covariance matrix.

FIG. 9B shows an illustrative flow chart depicting another example operation 910 for selecting a portion of a channel impulse response. The receiving device may identify a number of taps in the first channel impulse response (912), and then select a subset of the identified number of taps (914). For one example, referring also to FIG. 5, the receiving device may identify the first peak 511 and taps associated with the secondary lobes 520. For another example, referring also to FIG. 6, the receiving device may identify the first peak P1 and a number of taps within an earliest arrival portion 611 of the first channel impulse response 610.

FIG. 9C shows an illustrative flow chart depicting another example operation 920 for selecting a portion of a channel impulse response The receiving device may detect, in the channel impulse response, an earliest peak across a plurality of antennas of the receiving device (922). Then, the receiving device may identify a number of taps in the channel impulse response corresponding to a time period prior to the detected earliest peak (924).

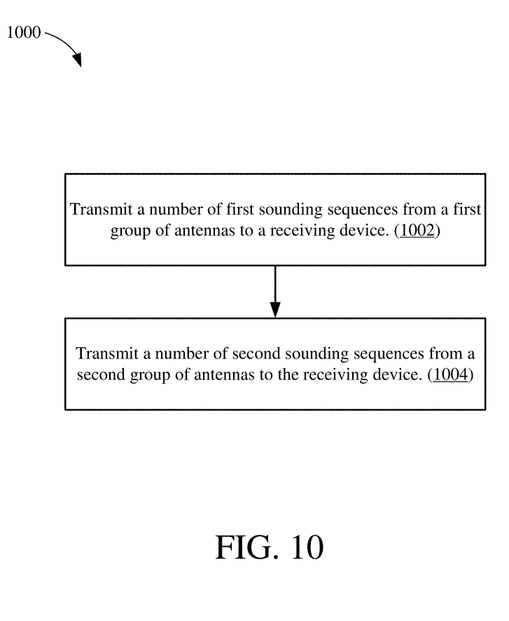

FIG. 10 shows an illustrative flow chart depicting an example operation for performing a channel estimation operation. For purposes of discussion herein, a transmitting device may transmit a wireless device to a receiving device, and the receiving device may estimate the AoA of the wireless signal. The transmitting device may be any suitable wireless device including, for example, one of the stations STA1-STA4 of FIG. 1, the AP 110 of FIG. 1, or the wireless device 200 of FIG. 2. Similarly, the receiving device may be any suitable wireless device including, for example, one of the stations STA1-STA4 of FIG. 1, the AP 110 of FIG. 1, or the wireless device 200 of FIG. 2.

The transmitting device may transmit a number of first sounding sequences from a first group of antennas to a receiving device (1002). The first sounding sequences may be orthogonal to each other, for example, as described above with respect to FIG. 3. The transmitting device may transmit a number of second sounding sequences from a second group of antennas to the receiving device (1004). The second sounding sequences may be orthogonal to each other, for example, as described above with respect to FIG. 3. Thereafter, the receiving device may estimate channel conditions based on the received sounding sequences to determine a channel frequency response of wireless signal received from the transmitting device, for example, as described above with respect to FIGS. 8 and 9A-9C.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A method of estimating angular or timing information of a wireless signal including a plurality of signal components associated with a number of different arrival paths, comprising:
receiving the wireless signal transmitted from a plurality of transmit antennas of a transmitting device;
estimating channel conditions, based on a number of sounding sequences, to determine a channel frequency response of the received wireless signal;
determining a channel impulse response based an inverse discrete Fourier transfer (DFT) function or a partial inverse DFT function of the channel frequency response;
selecting a portion of the channel impulse response; and
estimating an angle of arrival or timing information of the received wireless signal based on the selected portion of the channel impulse response.

2. The method of claim 1, wherein a separate sounding sequence is received from each of the plurality of transmit antennas.

3. The method of claim 1, wherein at least one group of the sounding sequences are orthogonal to one another according to a P-matrix encoding.

4. The method of claim 1, wherein a first group of the sounding sequences are offset from a second group of the sounding sequences according to a cyclic shift diversity (CSD) delay between a first group of the transmit antennas and a second group of the transmit antennas.

5. The method of claim 1, wherein each of the number of sounding sequences is at least one of a high efficiency long training field (HE-LTF), a very high throughput long training field (VHT-LTF), a high throughput long training field (HT-LTF), or a legacy long training field (LTF).

6. The method of claim 1, wherein the number of sounding sequences are contained in a null data packet (NDP) received from the transmitting device.

7. The method of claim 1, wherein the number of sounding sequences are contained in a packet extension of at least one packet received from the transmitting device.

8. The method of claim 7, wherein the number of sounding sequences contained in the packet extension is based on at least one of a number of antennas used to transmit the wireless signal or a duration of the packet extension.

9. The method of claim 8, further comprising:
storing a matrix of sounding sequences in a memory; and
decoding the received number of sounding sequences based on the matrix.

10. The method of claim 1, wherein the channel impulse response comprises:
a first channel impulse response corresponding to a first group of the signal components received from a first group of the transmit antennas; and
a second channel impulse response corresponding to a second group of the signal components received from a second group of the transmit antennas.

11. The method of claim 10, wherein selecting the portion of the channel impulse response comprises:
detecting a first peak in the first channel impulse response;
determining whether the first peak corresponds to a first group of the transmit antennas or to a second group of the transmit antennas;
detecting a position of the second group of the transmit antennas based on a cyclic shift diversity (CSD) delay between the first and second groups of transmit antennas;
detecting a second peak in the second channel impulse response; and
isolating the first channel impulse response from the second channel impulse response based, at least in part, on the detected first and second peaks.

12. The method of claim 11, wherein the first and second peaks are separated in time by the CSD delay between the first and second groups of transmit antennas.

13. The method of claim 12, wherein selecting the portion of the channel impulse response further comprises:
identifying a number of taps in the first channel impulse response; and
selecting a subset of the identified number of taps.

14. The method of claim 13, wherein the selected subset of the identified number of taps corresponds to signal components of the wireless signal arriving earliest at the receiving device.

15. The method of claim 13, wherein estimating the angle of arrival comprises:
determining channel information of the wireless signal based on the selected subset of the identified number of taps; and
deriving the angle of arrival based, at least in part, on the determined channel information.

16. The method of claim 15, wherein determination of the channel information is based on a covariance matrix of the selected subset of the identified number of taps.

17. The method of claim 10, wherein selecting the portion of the channel impulse response further comprises:
identifying, in the first channel impulse response, an earliest peak across a plurality of antennas of the receiving device; and
identifying a number of taps in the channel impulse response corresponding to a time period including and prior to the detected earliest peak.

18. The method of claim 17, wherein the identified earliest peak corresponds to a first arrival path of the wireless signal.

19. The method of claim 1, wherein selecting the portion of the channel impulse response comprises:
detecting, in the channel impulse response, an earliest peak across a plurality of antennas of the receiving device; and
identifying a number of taps in the channel impulse response corresponding to a time period prior to the detected earliest peak.

20. The method of claim 19, wherein the detected earliest peak corresponds to a first arrival path of the received wireless signal.

21. The method of claim 19, wherein estimating the angle of arrival comprises:
determining channel information of the wireless signal based on the identified number of taps; and
deriving the angle of arrival based, at least in part, on the determined channel information.

22. An apparatus for estimating angular or timing information of a wireless signal including a plurality of signal components associated with a number of different arrival paths, comprising:
one or more transceivers configured to receive the wireless signal from a transmitting device;
one or more processors; and
a memory comprising instructions that, when executed by the one or more processors, causes the apparatus to:
estimate channel conditions, based on a number of sounding sequences, to determine a channel frequency response of the received wireless signal from a plurality of transmit antennas of the transmitting device;
determine a channel impulse response based an inverse discrete Fourier transfer (DFT) function or a partial inverse DFT function of the channel frequency response;
select a portion of the channel impulse response; and
estimate an angle of arrival or timing information of the received wireless signal based on the selected portion of the channel impulse response.

23. The apparatus of claim 22, wherein the channel impulse response comprises:
a first channel impulse response corresponding to a first group of the signal components received from a first group of the transmit antennas; and
a second channel impulse response corresponding to a second group of the signal components received from a second group of the transmit antennas.

24. The apparatus of claim 23, wherein execution of the instructions to select the portion of the channel impulse response causes the apparatus to:
detect a first peak in the first channel impulse response;
determine whether the first peak corresponds to a first group of the transmit antennas or to a second group of the transmit antennas;
detect a position of the second group of the transmit antennas based on a cyclic shift diversity (CSD) delay between the first and second groups of transmit antennas;
detect a second peak in the second channel impulse response; and
isolate the first channel impulse response from the second channel impulse response based, at least in part, on the detected first and second peaks.

25. The apparatus of claim 23, wherein execution of the instructions to select the portion of the channel impulse response causes the apparatus to:
identify a number of taps in the first channel impulse response; and
select a subset of the identified number of taps.

26. The apparatus of claim 23, wherein the first and second peaks are separated in time by the CSD delay between the first and second groups of transmit antennas.

27. A method of performing channel estimation, comprising:
transmitting a number of first sounding sequences from a first group of antennas to a receiving device, wherein the first sounding sequences are orthogonal to each other; and
transmitting a number of second sounding sequences from a second group of antennas to the receiving device, wherein the second sounding sequences are orthogonal to each other.

28. The method of claim 27, wherein the first sounding sequences and the second sounding sequences are orthogonalized using a P-matrix and are at least one of a high efficiency long training field (HE-LTF), a very high throughput long training field (VHT-LTF), a high throughput long training field (HT-LTF), or a legacy long training field (LTF).

29. The method of claim 27, wherein the first sounding sequences are the same as the second sounding sequences.

30. The method of claim 27, further comprising:
applying a cyclic shift diversity (CSD) between the first and second groups of antennas.
